(19) United States
(12) Patent Application Publication
(10) Pub. No.: US 2003/0056439 A1
(43) Pub. Date: Mar. 27, 2003

(54) Apparatus for producing systhesis gases

(75) Inventors: Markus Wilhelm, Wachenheim (DE); Kay Hantke, Ludwigshafen (DE); Maximilian Walter, Neustadt (DE); Joerg Reininghaus, Birkenheide (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akiengesellschaft, Ludwigshafen (DE)

(21) Appl. No.: 10/207,992

(22) Filed: Jul. 31, 2002

(30) Foreign Application Priority Data
Aug. 10, 2001 (DE) 101 39 575.2

(51) Int. Cl. B01J 8/00

(52) U.S. Cl. 48/127.9

(57) ABSTRACT

An apparatus having at least two tubes (1, 2) which are arranged coaxially inside one another and project partially into the reactor is proposed for the production of synthesis gases by partial oxidation of carbon-containing fuels in a reactor without internals. The inner tube (2) has a device (8) for supplying the fuels and the outer tube (1) has a device (9) for supplying the combustion air. At the end, the tubes are conically tapered, so that a nozzle-like outlet opening (3) and an annular nozzle gap (4) are formed. To improve the resistance to wear, the tubes (1, 2) are in each case composed o two sections (1a, 1b) and (2a, 2b), the tube sections (1b, 2b) which extend into the reactor consisting of a high-melting metal alloy which is able to withstand high temperatures. The tube sections can be joined together in a positively and nonpositively locking manner by a screw thread or a flange structure (11, 12).

To represent the generic basis of the invention, the preamble of claim 1 works on the basis of a known apparatus (burner) as revealed in EP-A 0 545 281, which is used to produce synthesis gases by partial oxidation of carbon-containing fuels in a reactor without internals at elevated pressure and relatively high temperatures of 1000 to 1600° C. The burner has three tubes which are arranged coaxially inside one another and each have a conically tapering end, and a cooling chamber in the region of the burner outlet, the combustion air being passed through the inner and outer zones of the burner and the carbon-containing fuel being passed through the annular space formed by the inner tube and the middle tube.

To convert the fuel into synthesis gases as completely as possible and to keep the formation of soot which cannot be avoided to the lowest possible level, a specific relationship between the velocities of fuel and combustion air is to be maintained by process engineering means. Deviations lead to the particularly hot reaction zone being shifted away from the reactor center toward the burner. Not only does this effect promote the formation of soot on account of a poorer quality of mixing of the reaction partners in the reactor, but also causes the burner to be exposed to particularly high thermal loads. The result is rapid wear to the burner. Wear mechanisms are, firstly, oxidation and, secondly, corrosion through attack from sulfur and other slag formers. To extend the service life, in the burner according to EP-A 0 545 281, the end which faces the zone of partial oxidation is lined with a layer composed of individual ceramic platelets arranged next to one another. However, the oxidative conversion of carbon containing fuels leads to such high temperatures at and in the vicinity of the burner opening that the adjacent burner parts are also subject to rapid wear, for example as a result of oxidative processes and as a result of thermal stresses and cracking. Furthermore, attaching the ceramic platelets involves considerable outlay.

It is an object of the present invention to provide an apparatus for producing synthesis gases by partial oxidation of carbon-containing fuels in a reactor without internals which is free of the abovementioned drawbacks. A particular feature which is additionally required is that in the event of wear phenomena it is not necessary for the entire apparatus to be exchanged, but rather only the parts which are particularly at risk.

We have found that this object is achieved by the features given in the defining part of claim 1.

Unlike the known burner, in the apparatus according to the invention the tubes which are arranged coaxially inside one another and are generally circular in cross section are in each case composed of two tube sections, the connections between which are to be set in such a way that, in the installed position of the apparatus, they are located inside the reactor. While a metal of high thermal conductivity can be used for the upper tube sections, which lead out of the reactor, the lower tube sections, which are conically tapered at the end and form a nozzle gap between them, consist of a high-melting metal alloy which is able to withstand high temperature and includes one or more alloying constituents selected from the group consisting of hafnium (Hf), molybdenum (Mo), niobium (Nb), rhenium (Re), tantalum (Ta), tungsten (W) and/or zirconium (Zr). Metal alloys of tantalum and tungsten, tantalum and rhenium or tantalum and molybdenum are preferably considered, for example the alloys Ta5W, Ta10W or Ta4Re.

It is also possible for the lower tube sections to be produced from ceramic material or ceramic-reinforced metals.

Further measures will emerge from subclaims 2 to 4.

It has been found that a considerable increase in the service life of the apparatus can be achieved if the tube sections consist of a tantalum/tungsten alloy with a grain size of 8-10 ASTM. Such a fine-grained microstructure is obtained in a known way by a plurality of cycles of cold-forming with subsequent heat treatment of the pulverulent metals. It is preferable to carry out cold-forming with a degree of deformation of approximately 30% at the start of the cycles rising to 90% at the end of the working sequences. Between each step, a recrystallization anneal is carried out at a temperature of between 1100 and 1250° C.

The invention is explained in more detail below with reference to the drawings, in which

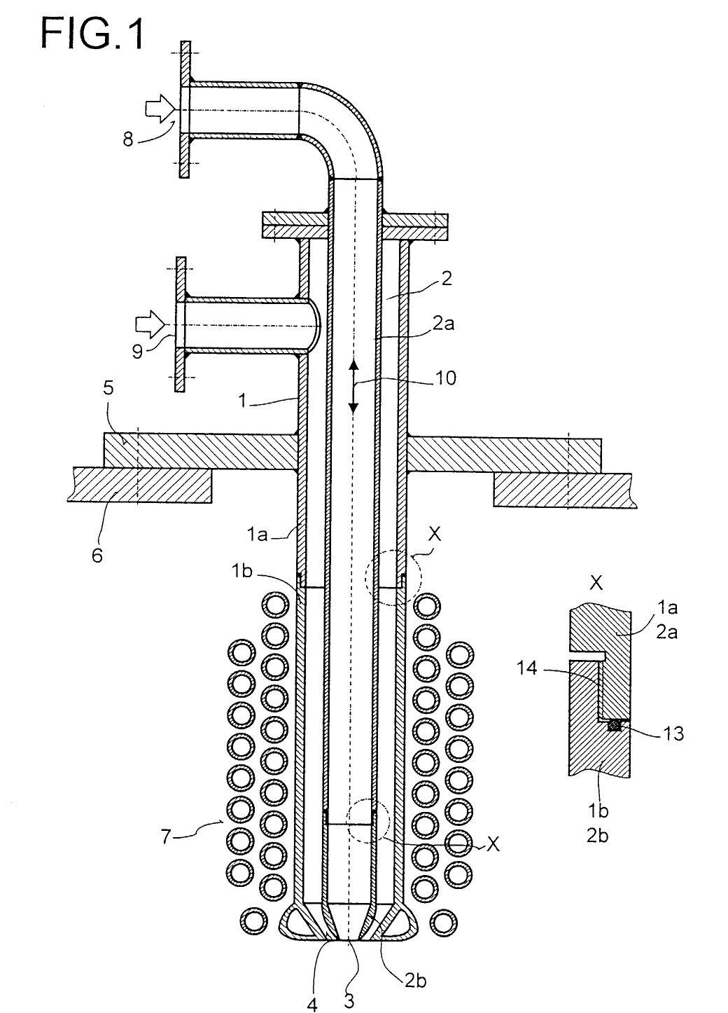

FIG. 1 shows a longitudinal section through the apparatus, in which the tube sections are screwed together, and

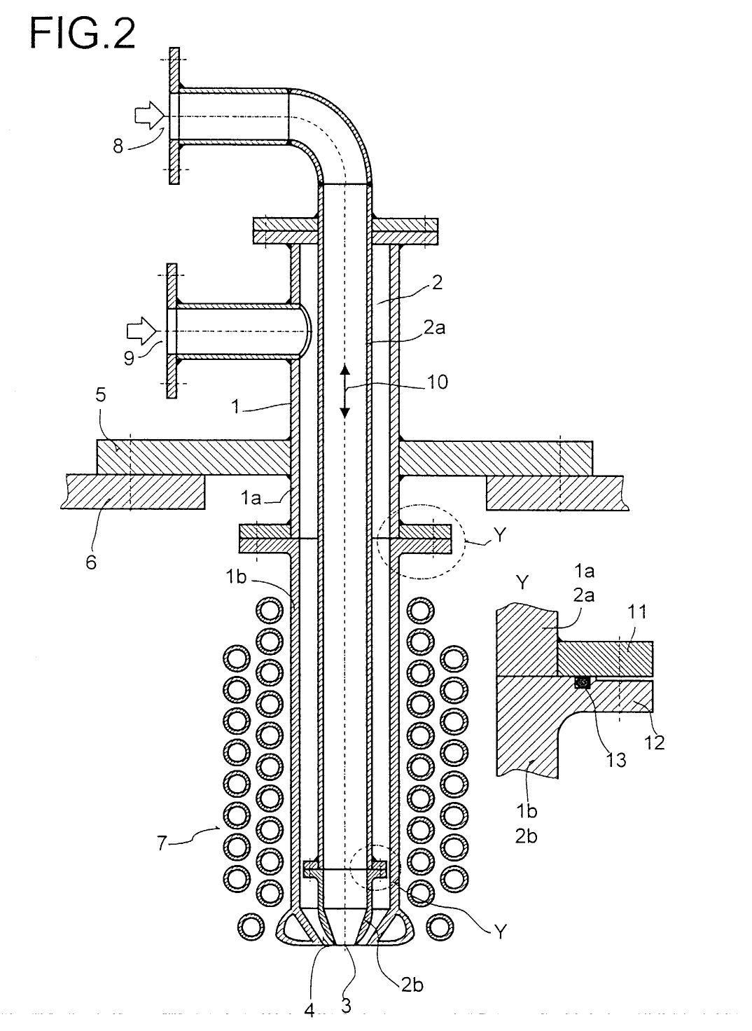

FIG. 2 shows a longitudinal section through the apparatus, in which the tube sections are connected to one another by means of flanges.

The apparatus for producing synthesis gases substantially comprises an outer tube I and inner tube 2 which is concentrically surrounded by the outer tube. The tubes are in each case composed of two tube sections (1a, 1b) and (2a, 2b), the free ends of the lower tub sections (1b and 2b) being conically tapered so that a nozzle-like outlet opening 3 and an annular nozzle gap 4 are formed. Shapes and arrangements of the conical tapered parts influenc the way in which the gas is produced, as does the distance between the tube ends. The outer tube 1 is attached to the wall of the reactor 6 by means of a flange connection 5. A cooling device is denoted by 7.

The tube 2 which is fitted into the outer tube 1 is generally used to supply the fuel. This takes place at 8, whereas the combustion air is fed into the annular gap formed between the tubes 1 and 2 via the device 9. The nozzle gap 4 can be varied in order to adapt the apparatus to different quantitative throughputs of combustion air, for example in part-load operation. For this purpose, the tube 2 can be displaced in the vertical direction, indicated in the figure by the double arrow 10.

According to the invention, the tube sections 1a and 1b and 2a and 2b are releasably connected to one another. This can be achieved by securing the sections to one another in a positively and nonpositively locking manner by means of a screw thread 14 or by means of a flange structure 11, 12. The sealing action is applied by means of a resilient, metallic seal, preferably by means of a flexible, metallic 0 ring 13. This means that it is not necessary for the entire apparatus to be produced from high-melting, expensive metal alloys which are able to withstand high temperatures, but rather only the lower tube sections 1b, 2b in the area of the apparatus which is exposed to particularly high thermal stresses, in particular in the vicinity of the nozzle gap 4, to be produced from such alloys.

The apparatus described is distinguished by a considerably longer service life than known apparatus. It ensures favorable gasification conditions both in part-load operation and in full-load operation, since the outlet velocity of the combustion air can be reduced considerably, which ultimately leads to reduced levels of soot being formed. Even frequent and rapid load changes have scarcely any effect on the wear behavior.

We claim:

1. An apparatus for producing synthesis gases by partial oxidation of carbon-containing fuels in a reactor without internals, having at least two tubes (1, 2) which are arranged coaxially inside one another, project partially into the reactor and of which the inner tube (2) has a device (8) for supplying the fuels and the outer tube (1) has a device (9) for supplying combustion air, the tubes are tapered conically at the end, and between them form a nozzle gap (4) and are surrounded, at least in the region of the nozzle gap, by a cooling chamber (7), wherein the tubes (1, 2) are each composed of two sections (1a, 1b) and (2a, 2b), the tube sections (1b) and (2b) which project into the reactor (6) consisting of a high-melting metal alloy which is able to withstand high temperatures and has one or more alloying constituent(s) selected from the group consisting of hafnium (Hf), molybdenum (Mo), niobium (Nb), rhenium (Re), tantalum (Ta), tungsten (W) and/or zirconium (Zr).

2. An apparatus as claimed in claim 1, wherein the tube sections (1b) and (2b) consist of a tantalum-tungsten alloy with a grain size of 8-10 ASTM.

3. An apparatus as claimed in claim 1, wherein the tube sections (1a, 1b) and/or (2a, 2b) can be screwed together.

4. An apparatus as claimed in claim 1, wherein the tube sections (1a, 1b) and/or (2a, 2b) can be connected to one another in a positively and nonpositively locking manner by means of a flange structure (11, 12).
